(19) United States
(12) Patent Application Publication
(10) Pub. No.: US 2018/0182149 A1
(43) Pub. Date: Jun. 28, 2018

(54) METHOD AND APPARATUS FOR CREATING USER-CREATED STICKER AND SYSTEM FOR SHARING USER-CREATED STICKER

(71) Applicant: Seerslab, Inc., Seoul (KR)

(72) Inventors: Jinwook CHONG, Seongnam-si (KR); Jaecheol KIM, Seoul (KR)

(21) Appl. No.: 15/847,918

(22) Filed: Dec. 20, 2017

(30) Foreign Application Priority Data
Dec. 22, 2016 (KR) 10-2016-0177062

(51) Int. Cl. G06T 11/60; G06F 3/0484; G06F 3/0489; G06T 7/13; G06T 19/20; G06T 13/40

(52) U.S. Cl. CPC G06T 11/60; G06F 3/04845; G06F 3/0489; G06T 7/13; G06T 19/20; H04L 51/10; G06T 2200/24; G06T 2207/10004; G06T 2219/2004; G06T 2213/08; G06T 13/40

(57) ABSTRACT

Provided is a method for creating a user-created sticker. The method includes displaying a subject, executing a tool for designing a sticker for decorating the displayed subject, receiving a user input for sticker design, identifying coordinates of a sticker design element generated according to the user input, generating relationship information associating the sticker design element with at least one of the subject and a display screen based on information on the identified coordinates of the sticker design element, and storing the user-created sticker based on the generated relationship information and the sticker design element.

### CROSS-REFERENCE TO RELATED APPLICATIONS

This U.S. non-provisional patent application claims priority under 35 U.S.C. § 119 of Korean Patent Application No. 10-2016-0177062, filed on Dec. 22, 2016, the entire contents of which are hereby incorporated by reference.

### BACKGROUND OF THE INVENTION

The present invention disclosed herein relates to a sticker for decorating a subject, and more particularly, to a method and an apparatus for efficiently applying a sticker for decorating a subject.

Recently, as electronics and communication engineering rapidly develop, user terminals (PC, smart phone, mobile phone, notebook, etc.) associated with communication have various functions.

That is, as the wired/wireless communication and data processing technologies rapidly develop, users may use functions such as Internet access, video communication, and video message transmission as well as voice communication using a communication terminal.

In addition, due to rapid distribution of communication terminals, a considerable amount of communication occurring in human relationships is performed through communication terminals, and communication terminals are becoming essential communication means in modern life.

Thus, as communication services including mobile communication are popularized and the spread of the mobile communication terminals is increased, the mobile communication terminals and existing user terminals are also being developed to include various functions and improve in terms of performance.

Particularly, smartphones which are mobile phones having various functions and performances are being developed, and many users purchase and use these smartphones.

Recently, through these smartphones, users are demanding various functions related to image photographing.

In particular, users want to display a subject photographed through a camera and generate a photographic file, and want to decorate the photographed subject with fun elements in a desired manner.

In order to provide such a function, various software programs are installed and run on user terminals in the form of an application (or referred to as an ‘app’).

However, in a typical method, since stickers beforehand stored in the terminal or the application have to be used, the sticker selection is limited, that is, a user cannot freely implement a desired decoration, thereby reducing the fun factor for a user.

In other words, even if a lot of stickers are stored, there is a limitation in that it is difficult to satisfy a user's demand and a design demand for a subject.

### SUMMARY OF THE INVENTION

The present invention provides a method and apparatus for creating a user-created sticker and a user-created sticker sharing system which allow a user to directly create a sticker and share the created sticker through a server.

Embodiments of the present invention provide methods for creating a user-created sticker comprising: displaying a subject; executing a tool for designing a sticker for decorating the displayed subject; receiving a user input for sticker design; identifying coordinates of a sticker design element generated according to the user input; generating relationship information associating the sticker design element with at least one of the subject and a display screen based on information on the identified coordinates of the sticker design element; and storing the user-created sticker based on the generated relationship information and the sticker design element.

The method may further include: identifying a contour of the subject; identifying a center point of the subject based on the identified contour of the subject; and generating relationship information by considering the center point of the subject, the contour of the subject, and the coordinates of each sticker design element.

The method may further include: identifying a contour of the subject; and generating a synchronization point that associates the sticker design element with the identified contour of the subject based on the coordinates of the sticker design element, wherein the user-created sticker is stored based on the synchronization point and the sticker design element.

The synchronization point may include a specific point on the contour of the subject having an association with an end of the sticker design element.

Information stored when the user-created sticker is stored may include information related to a synchronization point that is a specific point indicating an association between the sticker design element and the subject, and information on the sticker design element itself.

The sticker design elements may move together with the subject based on the relationship information when the subject moves.

The sticker design element may vary so as to have a size proportional to the size of the subject in response to a change in size of the subject.

The sticker design element may be created in plurality, and the plurality of sticker design elements may have relationship information with at least one subject.

The method may further include recognizing a specific motion of the subject and giving a moving effect to the user-created sticker in response to the recognized motion.

The sticker design element may include at least one of a text, a drawing, a figure, an image, and a functional figure that calls a sound and an animation.

When a drawing input is selected, a menu for selecting at least one of a thickness, a shape, and a color of a line for drawing may be provided.

When a text input is selected, a sticker generating apparatus may call a keyboard that is basically provided and allow a user to enter a text using the keyboard.

After a text is inputted, at least one of a size, a position, and a tilt of the inputted text may be changeable.

The figure and the image may be called from a camera or an album to be used.

The figure may include a still figure, an animation figure, or a 3D object.

The user-created sticker may be created in a state of being photographed by a camera or may be created using a pre-stored photograph.

The user-created sticker may be created in addition to a pre-stored sticker.

In other embodiments of the present invention, apparatuses for creating a user-created sticker include: a display unit for displaying a subject; an input unit receiving a user input; a sticker generating unit executing a tool for designing a sticker for decorating the displayed subject through a control signal inputted through the input unit, generating a sticker design element according to a user input for designing a sticker, identifying coordinates of the generated sticker design element, and generating relationship information associating the sticker design element with at least one of the subject and a display screen based on information on the coordinates of the identified sticker design element; and a storage unit for storing a user-created sticker based on the generated relationship information and the sticker design element.

In still other embodiments of the present invention, systems for sharing a user-created sticker include: a user-created sticker generating apparatus executing a tool for designing a sticker for decorating a displayed subject through an input unit, generating a sticker design element according to a user input for designing a sticker, identifying coordinates of the generated sticker design element, generating relationship information associating the sticker design element with at least one of the subject and a display screen based on information on the coordinates of the identified sticker design element, storing a user-created sticker based on the generated relationship information and the sticker design element, and transmitting the stored user-created sticker to a server; and a server for receiving the user-created sticker and distributing the user-created sticker to other apparatuses.

The system may further include a user-created sticker receiving apparatus downloading and using the user-created sticker through the server or directly from the user-created sticker generating apparatus.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a method of using a sticker for decorating a photographed subject through a general photographic application;

FIG. 2 is a flowchart illustrating a method of creating a user-created sticker according to an embodiment of the present invention;

FIG. 3 is a flowchart illustrating a process of generating a sticker design element in accordance with a user input of a user-created sticker creating method according to an embodiment of the present invention;

FIG. 4A is a view illustrating a screen of an actual application for implementing a method of generating a user-created sticker according to an embodiment of the present invention.

FIG. 4B is a conceptual view illustrating a first embodiment of associating a subject with sticker design elements displayed on the screen;

FIG. 4C is a conceptual view illustrating a second embodiment of associating a subject with sticker design elements displayed on the screen;

FIG. 5 is a view illustrating a screen for inputting texts to create a user-created sticker according to a method of generating a user-created sticker according to an embodiment of the present invention;

FIG. 6 is a view illustrating a method of adjusting a size and a position of an inputted text according to a method of generating a user-created sticker according to an embodiment of the present invention;

FIG. 7 is a view illustrating a method for inserting a moving effect into a sticker design element generated according to a method of generating a user-created sticker according to an embodiment of the present invention;

FIG. 8 is a view illustrating a screen displaying a user-created sticker designed by combining a first mode and a second mode of a method of generating a user-created sticker according to an embodiment of the present invention;

FIG. 9 is a view illustrating an apparatus for generating a user-created sticker according to an embodiment of the present invention;

FIG. 10 is a detailed view illustrating a sticker generating unit of a user-created sticker generating apparatus according to an embodiment of the present invention; and

FIG. 11 is a conceptual view illustrating a system for sharing a user-created sticker according to an embodiment of the present invention.

### DETAILED DESCRIPTION OF PREFERRED EMBODIMENTS

Since the present invention may be modified into various types and may be implemented into various embodiments, specific embodiments will be illustrated in the drawings and described in this disclosure in detail.

However, the present invention is not limited to a specific implementation type, but should be construed as including all modifications, equivalents, and substitutes involved in the spirit and the technical scope of the present invention.

The terms such as “a first/the first” and “a second/the second” may be used to describe various components, but the components should not be limited by the terms.

The terms are used only in order to distinguish one component from another component.

For example, a first component may be named a second component without deviating from the scope of the present invention, and similarly, the second component may be named the first component.

The term “and/or” includes a combination of a plurality of related items or any one of a plurality of related items.

It should be understood that when an element is referred to as being “connected” or “coupled” to another element, it may be directly connected or coupled to the other element but another element may also be interposed therebetween.

On the other hand, when an element is referred to as being “directly connected” or “directly coupled” to another element, it should be understood that there are no other elements in between.

The terms used herein are used only to describe specific embodiments, and are not intended to limit the present invention.

The singular forms “a,” “an,” and “the” include plural referents unless the context clearly dictates otherwise. In this disclosure, the terms “include,” “comprise,” or “have” specify features, numbers, steps, operations, elements or combinations thereof, but do not exclude existence or addition possibility of one or more other features, numbers, steps, operations, elements or combinations thereof.

Unless described otherwise, all terms used herein including technical or scientific terms may include the same meaning as those generally understood by persons skilled in the art to which the present invention belongs.

Terms as defined in dictionaries generally used should be construed as including meanings which accord with the contextual meanings of related technology. Also, unless clearly defined in this disclosure, the terms should not be construed as having ideal or excessively formal meanings.

Hereinafter, exemplary embodiments of the present invention will be described in detail with reference to the accompanying drawings.

In order to help the overall understanding of the present disclosure, the same reference numerals will be used for the same elements in the drawings, and a duplicate description of the same elements will be omitted.

In one aspect of the present invention, the sticker creation may be performed by executing an application associated with photographing.

A performing device may be referred to as a user terminal, and the user terminal includes an apparatus having a computing function.

For example, the user terminal may be referred to as a Mobile Station (MS), a User Equipment (UE), a User Terminal (UT), a wireless terminal, an Access Terminal (AT), a terminal, a fixed or mobile subscriber unit, a Subscriber Station (SS), a wireless device, a wireless communication device, a Wireless Transmit/Receive Unit (WTRU), a mobile, a mobile station, a Personal Digital Assistant (PDA), a smart phone, a laptop, a netbook, a Personal Computer (PC), Consumer Electronics (CE) or other terminologies.

Various embodiments of the terminal may include cellular phones, smart phones having a wireless communication function, Personal Digital Assistants (PDAs) having a wireless communication function, wireless modems, portable computers having a wireless communication function, photographing devices such as digital cameras having a wireless communication function, home appliances having a wireless communication function, Internet home appliances capable of wireless Internet access and browsing, and portable units or terminals incorporated with combinations of such functions, but are limited thereto.

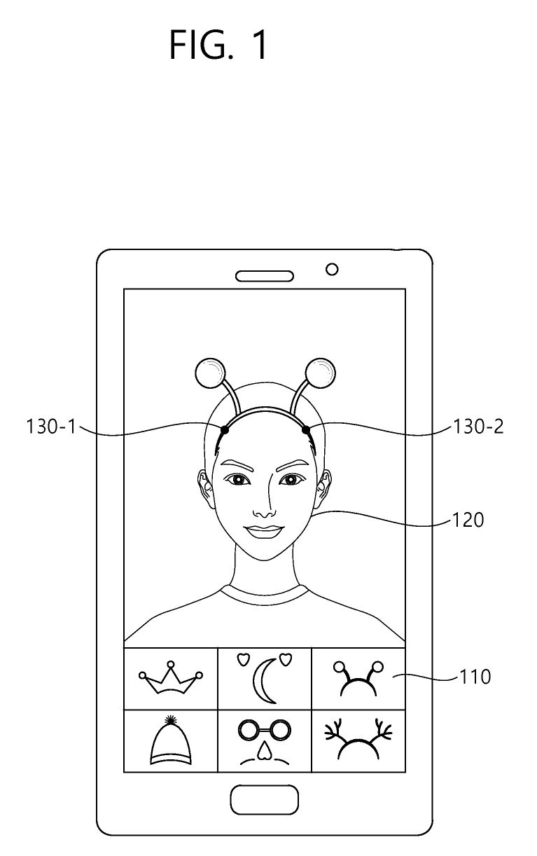

Throughout this specification, the term sticker refers to a design for decorating a subject photographed by a camera and displayed on a display unit, and includes designed objects of a woolen hat shape and a headband shape in FIG. 1.

The sticker may include a plurality of sticker design elements, and the sticker design element refers to each element design included in the sticker.

For example, in a sticker 110 shown in FIG. 1, a half-moon headband body portion at a lower end, a circle shape at a left side, a circle shape at a right side, a line connecting the left circle and the body portion, and a line connecting the right circle and the body portion may be each considered as one sticker design element.

General Sticker Application

FIG. 1 is a view illustrating a method of using a sticker for decorating a photographed subject through a photographing application.

Referring to FIG. 1, when a photographing application is executed in general, a sticker pre-stored in a terminal or an application is fetched and applied to a subject while the subject photographed through a camera of a user terminal is being displayed on a display unit.

A variety of stickers such as a crown shape, a woolen hat shape, an eyeglass shape, and a headband shape at the bottom of FIG. 1 may be stickers pre-stored in a terminal or an application, and a user may select one of the stickers 110.

When the selected sticker 110 is applied to a subject, the selected sticker 110 is applied in consideration of a contour 120 of the subject.

The subject's contour 120 is identified based on the pixels representing the contour line.

Then, the contour 120 of the identified subject is matched with an edge template, and the sticker 110 is applied by considering a point on the contour 120 of the subject corresponding to a specific point on the matched edge template.

In the example of FIG. 1, a headband sticker 110 is applied to the face. When a user selects the sticker 110, the contour 120 of the face of the currently displayed subject is identified, synchronization points 130-1, 130-2 at which the contour 120 of the subject and the sticker 110 are connected are sought based on the synchronization points of the edge templates that are pre-stored.

Then, the selected sticker 110 is applied to the face contour 120 of the subject in consideration of the synchronization points 130-1 and 130-2.

User-Created Sticker Creating Method

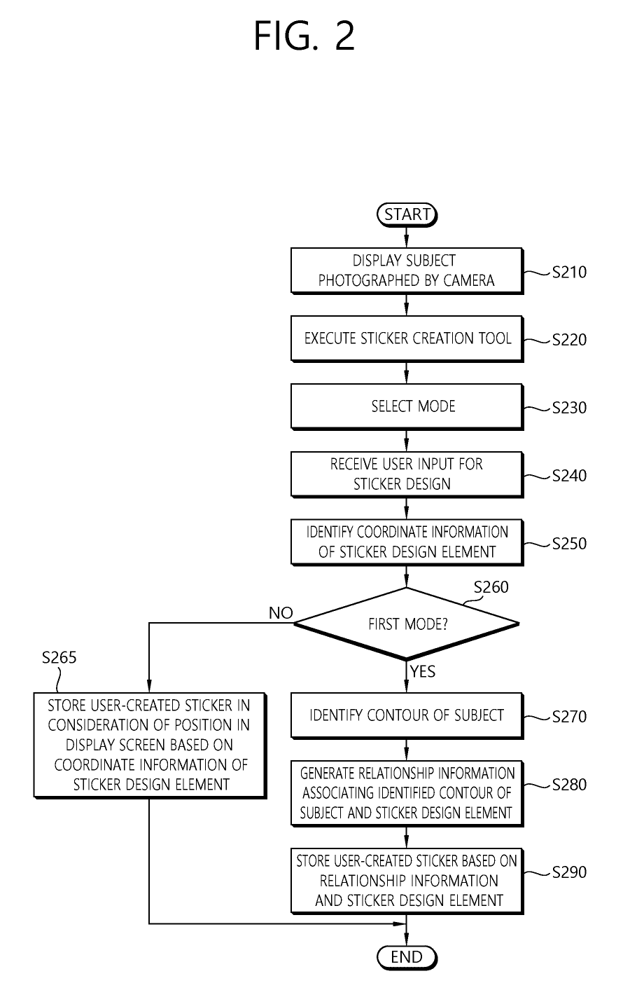

FIG. 2 is a flowchart illustrating a method of creating a user-created sticker according to an embodiment of the present invention.

Referring to FIG. 2, a user terminal executes an application related to photographing and displays a subject photographed by a camera (S210).

Then, a sticker creation tool is executed (S220).

The sticker creation tool may be provided as one function of menus of the photographing application.

When a user selects the sticker creation tool, the terminal displays a menu for sticker creation on the display screen.

According to another embodiment of the present invention, a sticker may be created using photographs or videos previously stored in the terminal, not during photographing.

Next, a mode for sticker creation is selected (S230).

Here, the mode for creation may include two modes, i.e., a first mode and a second mode.

The first mode is a mode for recognizing a subject such as a face, and associates a sticker design element generated by a user input with at least one of displayed subjects.

In this case, the contour of the subject may be considered as an element determining the relationship with the sticker design element.

The contour of the subject may be identified using pre-stored edge templates.

For example, when a subject is a face, edge templates including the overall layout information of a plurality of components such as eyes, nose, and mouth in the face are stored in advance, and the contour of the face and the contours of the components in the face displayed on the displayed screen are matched with the pre-stored edge templates to first recognize the face and identify and store the contour information of the recognized face.

In this case, information such as brightness, motion, color, and eye position estimation may be used to distinguish the face and the background.

In this case, it is effective to analyze the main part of the face, discard the fine error, capture only the large feature, and compare with the stored face template.

In the embodiment of the present invention, the edge template is not necessarily related to the face, but may be related to other parts of the human body such as arms, legs, hands, and the like.

In the first mode, due to the association with the subject, the sticker design element generated by a user in response to a motion of the subject and/or a change in the size of the subject may also move and change in size.

The second mode is a mode for designing to display a subject at a specific position on the display screen in consideration of the association with the displayed screen instead of the association with the subject.

In the second mode, the sticker design element may be displayed at a fixed size at a predetermined position in the display screen without being affected by the motion of a subject.

In some cases, in the second mode, a moving effect such as a change in size may also be given according to the setting of the user.

When the mode selection is completed, a user receives a user input for the sticker design through a user interface (e.g., a touch screen, a keyboard, a mouse, etc.) (S240).

The user input for the sticker design may be a text input, and may be an input through a drawing mode.

The drawing mode may be referred to as a doodling mode.

A sticker design element may be created by inputting a text input through typing using a keyboard, and a sticker may be created by inputting a line or a figure selected by a user through a mouse or a touch screen in a drawing mode.

According to an embodiment of the present invention, figures and images may be imported in addition to the text and drawings.

The figures may include a still figure, an animation graphic, or a 3D subject, and the images may be imported from a camera or album and may be used as a sticker design element.

The figures may include solid lines, triangles, squares, arrows, bent lines, half-moon shapes, clouds, hearts, mathematical expression-related figures, flowchart-related figure, and the like.

These figures may be stored in a template in advance.

According to another embodiment of the present invention, other effects such as a sound and a functional figure capable of calling a specific animation may be utilized as sticker design elements.

The user terminal identifies in-screen coordinate information of each sticker design element to memorize the inputted sticker design element as a user-created sticker (S250).

The coordinate information is recognized by identifying the coordinates of pixels related to the sticker design element in the displayed screen.

The identified coordinate information may be utilized as relationship information indicating an association with a display screen or a subject in accordance with a mode selected by a user.

After identifying the coordinates of the inputted sticker design element, it is determined whether the mode is the first mode or the second mode (S260).

The first mode (subject recognition mode) is allowed to have an association with the contour of the subject, and the second mode is allowed to have an association with the display screen.

The switching between the first mode and the second mode is possible at any time before the sticker is stored. Accordingly, upon sensing of a mode change, all of the sticker design elements interpreted with the second mode may be interpreted with the first mode.

That is, the sticker design elements analyzed through operation S265 may be interpreted through operations S270 to S290, and vice versa.

If the first mode is selected in operation S260, first, the contour of a subject is identified using the edge template (S270).

The terminal stores a figure (e.g., a rectangle) including all the sticker design elements as an image, and recognizes a subject in the stored image to identify the contour of the identified subject.

In this case, there may be a plurality of subjects in the image.

For example, the face may be a subject, and other parts of a person such as hand and arm may be a subject.

The user terminal recognizes a subject based on a pre-stored edge template of the subject, and identifies the contour of the subject.

In this case, coordinate information of the pixel related to the contour can be checked.

Relationship information for associating the contour of the identified subject with the sticker design element is generated based on the coordinate information of the sticker design element identified in operation S250 (S280).

According to an embodiment of the present invention, the center point of the subject is searched based on the contour of the subject included in the stored image.

Then, based on the distance from the center point to the contour of the subject, the relationship between the sticker design element and the subject may be grasped by considering the distance from the contour of the subject or the center point to the sticker design element.

Then, the relationship information may be generated based on the grasped relationship.

According to another embodiment, in operation S280, a point corresponding to the synchronization point is searched on the pre-stored edge template.

The synchronization point, which is a point for synchronizing the contour of the actual subject currently displayed, the sticker design element and the pre-stored edge template, may be specified as a specific point on the contour of the subject.

For example, a specific point on the contour of the subject having an association with the end of the sticker design element becomes a synchronization point.

Alternatively, the start point and/or the end point of the sticker design element and the nearest point on the contour may become synchronization points.

In some cases, a point at which the sticker design element and the contour meet each other may become a synchronization point.

Thus, there are various algorithms for determining the synchronization point, and this may be determined by user setting.

The synchronization point on the contour of the actual subject corresponds to a specific point on the edge template that is matched with the subject, and based thereon, may be appropriately applied to another subject to which the edge template is applied.

The generated synchronization point may be considered as the relationship information.

When the relationship information is generated, the user terminal stores a user-created sticker in a local area based on the relationship information and the sticker design element (S290).

In this case, a user may instruct to perform storage by pressing a storage icon.

That is, if it is determined that a user has created a preferred sticker to such an extent as to register as a sticker while creating user-created stickers as a fun factor through the process from operation S210 to operation S280, the user may register and save the sticker that is currently being implemented.

That is, the storage of the sticker may also be selectively determined according to the preference of the user.

In this case, the sticker-related information that is stored may include the relationship information, the information on the contour of the subject and each sticker design element coordinates, and the information on the sticker design element itself.

Alternatively, related edge template information may be further stored.

In this case, the relationship information may include synchronization point information (e.g., a specific point on the subject or a point on the edge template corresponding to the specific point) and information (e.g., distance information, etc.) indicating a relationship between the synchronization point and the sticker design element.

The information on the sticker design element itself may include the type of the sticker design element (whether the sticker design element is text or drawing), and in case of drawing, may include information on the color, thickness, shape, etc. of the line forming the sticker design element.

If the second mode is selected in operation S260, the procedure enters the second mode, and a user-created sticker is created and stored in consideration of the position in the display screen based on the coordinate information of the sticker design element (S265).

In this case, information related to the subject is not stored, and only the coordinate information in the display screen may be stored for association with the display screen.

Since the subject may continue to move and change in size during the photographing except a case where pre-stored pictures are used, the time point at which the contour of the subject and the pixel coordinates of the sticker design element are identified may be important.

According to an embodiment of the present invention, the time point at which the contour of the subject and the coordinates of the sticker design element are identified may include a time point at which a user input for creating a sticker design element starts or a time point at which a user input is completed.

The subject and the sticker design element are identified in accordance with the corresponding time point, and the sticker design element also changes corresponding to the change of the subject after the corresponding time point.

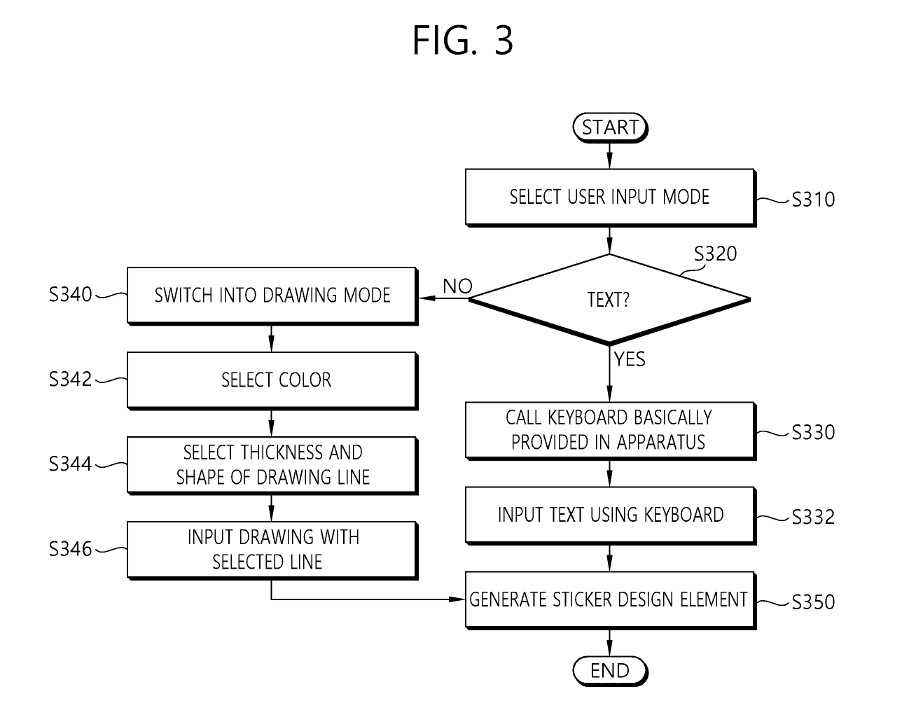

FIG. 3 is a flowchart illustrating a process of generating a sticker design element in accordance with a user input of a user-created sticker creating method according to an embodiment of the present invention.

Referring to FIG. 3, in order to generate a sticker design element, the type of sticker design element is selected (S310).

The type may be a text or a drawing.

The terminal determines whether or not the type is a text type (S320). If a sticker design element of text type is selected to be created, the terminal calls a keyboard that is basically provided (S330).

According to another embodiment, a special keyboard directly provided in the currently running application for sticker creation may be used.

After the keyboard pops up, a user inputs text using the keyboard (S332).

In this case, emoticons provided by keyboard may also be utilized in addition to letters, numbers and symbols.

The emoticons may be processed as images, and then may be processed such that the shape or size thereof is changed according to a user input later.

After inputting the text, the size, position and/or tilt of the text may be adjusted through a user interface.

When the above process is completed, a sticker design element is generated based on information on the contents, size, position, and/or tilt of the finally adjusted text (S350).

If the text type is not selected in operation S320, the sticker design element creation process is switched to the drawing mode (S340).

Then, a menu for selecting the color of a basic line for drawing in the drawing mode is displayed (S342).

After a user selects the color of the line, a menu for selecting the thickness and shape of the line is displayed, and a user may select a line of a specific thickness and shape in the menu (S344).

The order of selection of color, thickness, and/or shape of the line is not necessarily the same as in this embodiment, but may be selected in a different order.

After the color, thickness, and/or shape of the line are selected, a user performs drawing using the selected line through the user interface (S346).

The terminal may generate a sticker design element according to the drawn form (S350).

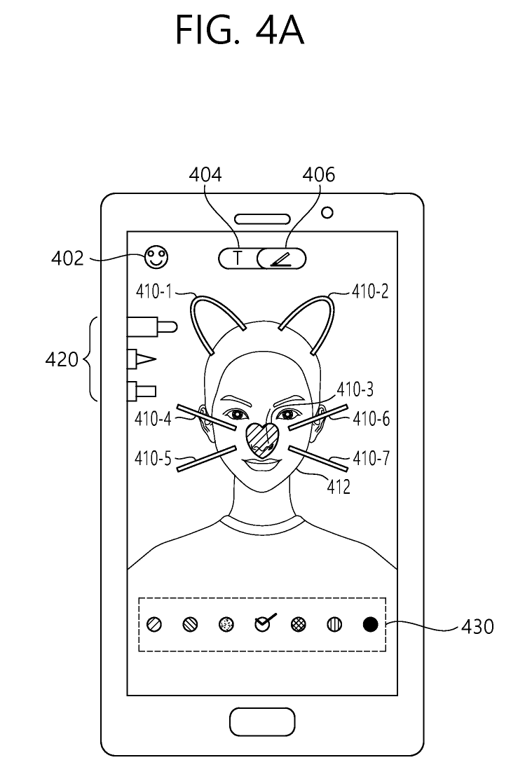

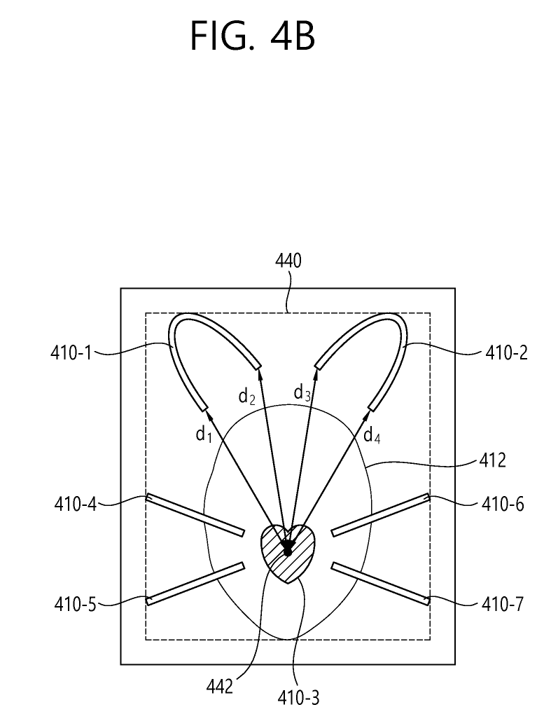

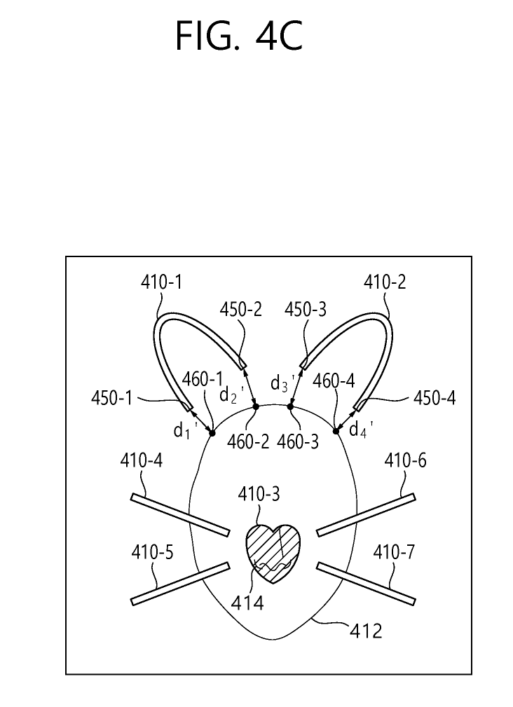

FIG. 4A is a view illustrating a screen of an actual application for implementing a method of generating a user-created sticker according to an embodiment of the present invention.

Referring to FIG. 4A, a tool for creating a user-created sticker displays an icon 402 for selecting the first mode and the second mode at the top of a display screen, and icons 404 and 406 for selecting the type of the sticker design element.

When the icon 402 is pressed, the first mode operates and thus the sticker moves in linkage with the contour of the subject. If the icon 402 is not pressed, the contour of the subject is not recognized because there is no association operation with the subject.

The embodiment of FIG. 4A assumes a situation where the first mode is selected.

In addition, when the icon 404 is selected, a text can be inputted, and when the icon 406 is selected, a user input can be performed in the drawing mode.

The embodiment of FIG. 4A assumes a situation where the drawing mode is selected.

In the drawing mode, a user may select the thickness and shape of a line through a menu 420 for selecting a basic line for drawing at the left side of the screen.

A user may arbitrarily change the thickness and shape of the line using the menu 420 during the drawing.

For example, in regard to the thickness of the line, a menu for selecting a plurality of thicknesses from the thickest line at the top to the thinnest line at the bottom may be provided.

Also, a menu (menu for selecting a pen type or a brush type) for selecting the shape of a line may include options such as a triangular shape line, a rectangular shape line, a circular shape line, a heart shape line, a line with two colors mixed, a line with a solid effect, a line with a shadow effect, and the like.

In addition, a menu 430 for selecting the line color may be provided at the bottom of the screen.

A user may select one of a plurality of provided colors to perform drawing.

In the embodiment of FIG. 4A, a user is photographing the upper body of the human body including the face, and the user terminal displays an image of the upper body.

A user creates a plurality of sticker design elements 410-1 to 410-7 by performing drawing with the thickness, shape, and color of the line selected through the menu 420 and the menu 430 while being photographing in real-time.

Different lines may be used through menu 420 and menu 430 whenever there is an input for each of sticker design elements 410-1 to 410-7.

On the whole, the sticker design elements 410-1 and 410-2 are formed at the top of the face to form a rabbit ear shape.

The sticker design element 410-3 is formed near the nose in the shape of a heart, and the sticker design elements 410-4 to 410-7 form a whisker shape in a form of radiating from the nose.

Hereinafter, a method of recognizing the sticker design elements 410-1 to 410-7 and saving as a whole user-created sticker by the user terminal will be described in detail. The user terminal individually recognizes and associates each sticker design element 410-1 to 410-7 with a subject.

That is, the subjects associated with the sticker design elements 410-4 to 410-7 may be different.

The sticker design element may be recognized as a figure formed of one connected line and as a unit of characters typed at a time.

FIG. 4B is a conceptual view illustrating a first embodiment of associating a subject with sticker design elements displayed on the screen.

Referring to FIG. 4B, when a sticker design element is created by a user input, the terminal stores a FIG. 440 including all the sticker design elements in a form of image.

Then, the terminal identifies a subject included in the FIG. 440.

In the embodiment of FIG. 4B, the face may be identified by the subject in the image.

In this case, the subject is recognized as a face by matching the contour of the subject and the pre-stored face template, and the face contour information may be obtained based on the recognized face.

When the face contour is obtained, the coordinates of the center point 442 of the face may be secured based on the face contour information.

Then, based on the relationship between the coordinates of the face center point 442 and the contour of the face, relationship information between the subject (face) and each of the sticker design elements 410-1 to 410-7 is generated.

For example, the relationship between a distance from the face center point 442 to the face contour and distances (including d1, d2, d3, d4) between the face center point 442 and each of sticker design elements 410-1 to 410-7 may be generated as the relationship information.

Alternatively, distances between the face contour and each of the sticker design elements 410-1 to 410-7 may be considered as the relationship information.

When the distances to each of sticker design elements 410-1 to 410-7 are calculated, it may be desirable to consider the start and end points of each of sticker design elements 410-1 to 410-7.

Based on the generated relationship information, since the distance from the center point to the contour of the face is changed when the face contour changes (e.g., when the shape of the face changes or the size of the face changes), the distances from the center point to each of sticker design elements 410-1 to 410-7 may also be changed in proportion to the changed distances.

FIG. 4C is a conceptual view illustrating a second embodiment of associating a subject with sticker design elements displayed on the screen.

Referring to FIG. 4C, a sticker design element 410-1 starts inputting at a start point 450-1, and ends inputting at an end point 450-2.

The user terminal may recognize the start point 450-1 and end point 450-2, and may identify a subject to be associated.

In this embodiment, the “face” closest to the sticker design element 410-1 and having a high matching degree is selected as a subject to be associated.

In this case, the subject is recognized as the face by matching the contour of the subject with the pre-stored face template, and information on the face contour 412 may be obtained based on the recognized face.

The user terminal searches for a synchronization point to clarify the relationship with the subject, i.e., the face contour 412, which is associated with the sticker design element 410-1.

The synchronization point, which is a point on the face contour 412, may preferably have a specific relationship with the start point 450-1 and the end point 450-2.

For example, the nearest point from the start point 450-1 and the end point 450-2 may be preferable.

Alternatively, a point on the contour 412 which meets the sticker design element 410-1 may become a synchronization point.

The information related to the synchronization point includes coordinate information indicating a point on the contour of the subject, and the information related to the synchronization point also becomes information stored in the terminal when the user-created sticker is stored.

In this embodiment, points 460-1 and 460-2, which are points on the face contour 412 closest to the start point 450-1 and the end point 450-2, may be detected as the synchronization points.

After the user terminal detects the synchronization points 460-1 and 460-2, the user terminal calculates distances d1′ and d2′ between the face contour 412 and the start point 450-1 and the end point 450-2, and stores the distances d1′ and d2′ as relationship information.

That is, even if applied to another face, the created sticker may be reproduced in such a manner that the sticker design element is created at the distances d1′ and d2′ away from the synchronization points.

In this case, if the size of the face changes, the distances d1′ and d2′ may also be reduced or increased in proportion to the changed size.

That is, even if the shape or scale of the face is changed, the sticker design element may be appropriately applied by searching for the coordinates corresponding to the coordinates of the synchronization points of the current face from the changed face.

In addition, the shape and scale of the sticker design element may be appropriately resized by identifying the coordinates of the whole pixels, on which the sticker design elements are displayed, to recognize and store the shape and by responding to changes in the size and shape (tilt, etc.) of the subject later.

For example, when the size of the subject is changed, the size as well as the coordinates of the synchronization point may also be changed so as to correspond to the size of the changed subject while maintaining the shape of the sticker design element.

Next, in the case of the sticker design element 410-3, the relationship with the face contour 412 may also be considered, but the relationship with the nose contour 414 is also considered.

Accordingly, in this case, a plurality of synchronization points may be detected with respect to the contours 412 and 414 of a plurality of subjects, and relationship information with the detected plurality of synchronization points may be generated and stored.

According to another embodiment of the present invention, a sticker design element that covers the whole of the face may be created.

In this case, considering the relationship with the face contour 412, when the face is displayed small, the size of the sticker design element also becomes small enough to cover the reduced face, and when the face is displayed large, the size of the sticker design element also becomes large enough to cover the enlarged face.

The size and shape of such a sticker design element and the position change of the synchronization points may be automatically changed in response to a change in the size and shape of the subject being photographed in real-time.

Text Input

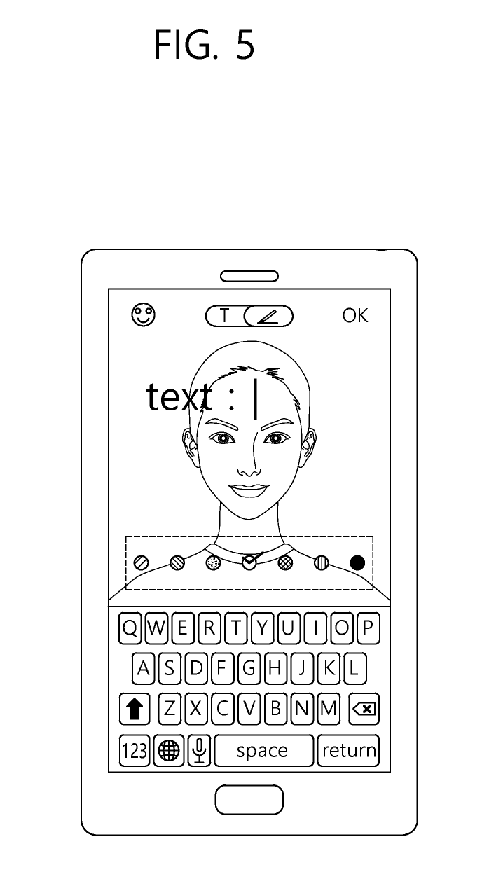

FIG. 5 is a view illustrating a screen for inputting texts to create a user-created sticker according to a method of generating a user-created sticker according to an embodiment of the present invention.

Referring to FIG. 5, a user may input a text by selecting a text input icon at the top of the display screen of the terminal.

When a text input is selected, the terminal may call a basically used keyboard for typing.

A user may input a text using the keyboard.

In this case, the color of the inputted text may be selected.

In addition, the emoticon provided via the keyboard of the terminal may also be inputted.

As described above, the inputted emoticons are processed as images.

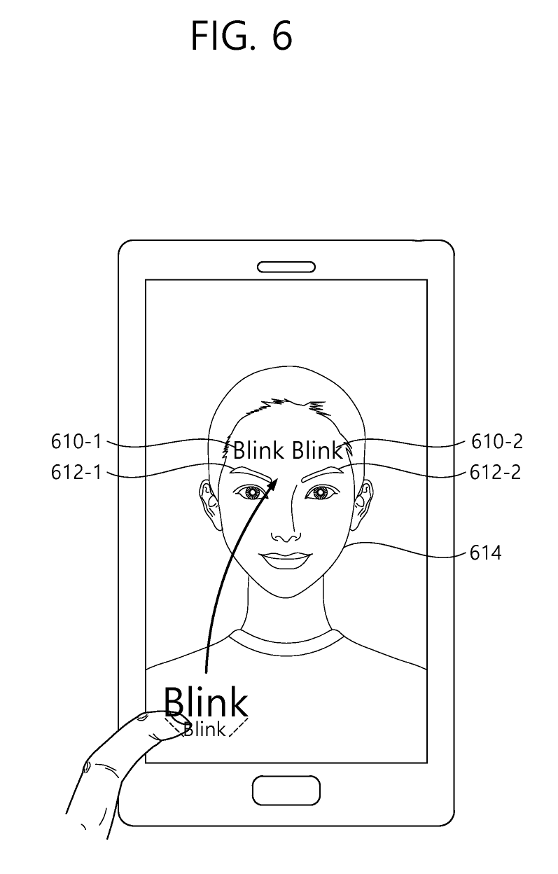

The inputted text may also be changed in size, position and the like, which will be described in detail with reference to FIG. 6.

FIG. 6 is a view illustrating a method of adjusting a size and a position of an inputted text according to a method of generating a user-created sticker according to an embodiment of the present invention.

Referring to FIG. 6, after a text “Blink” is inputted through the method of FIG. 5, the size and position of the text inputted through the user interface can be changed.

If a user presses the inputted text for a predetermined time after inputting the text, the terminal detects that the touch is performed for a time longer than a preset time, and changes the size of the text.

In the case of a mouse input, if the button is clicked for a predetermined time or longer, the terminal may detect this and perform the size change of the text.

Through the input for changing the size of text, the text may be changed into a size larger or smaller than the default size.

In some cases, a user may touch two fingers on a portion where the text is located, and may put two fingers together to reduce the size of the text or spread two fingers to enlarge the size of the text.

The input of a command for changing the text size according to this touch recognition may be arbitrarily changed through the user setting.

After changing the text into a size desired by a user, the position of the text may be moved.

A user can move the text by sliding the text to a desired position while touching the text.

In the embodiment of FIG. 6, texts 610-1 and 610-2 are placed over both eyebrows 612-1 and 612-2 that are displayed.

In this case, when a user selects the first mode of recognizing a subject, the texts 610-1 and 610-2 may be allowed to have an association with the subjects (eyebrows) 612-1 and 612-2 as one sticker design element, respectively.

At this time, both ends of the texts 610-1 and 610-2 may also be changed to a form of facing downward in accordance with the eyebrow shape.

That is, the shape of the text may be changed, for example, by changing the text into a bent shape.

Also, the texts 610-1 and 610-2 may be variously described, for example, by adding a blinking effect to the texts 610-1 and 610-2.

Insertion of Moving Effect into Sticker Design Element

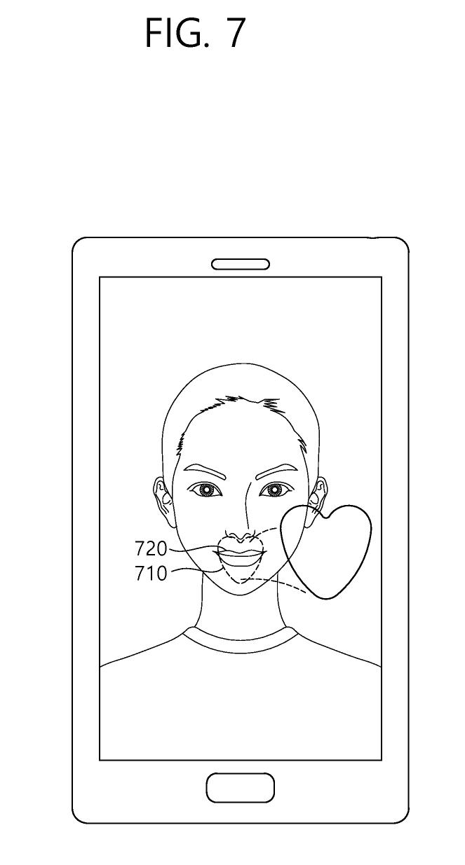

FIG. 7 is a view illustrating a method for inserting a moving effect into a sticker design element generated according to a method of generating a user-created sticker according to an embodiment of the present invention.

Referring to FIG. 7, a user may create a heart-shaped sticker design element 710 on a subject via a photographing application.

In this case, the sticker design element 710 may have its own moving effect in response to the movement of lips 720 while having an association with the lips 720.

For example, the sticker design element 710 may be set to have a moving effect of being flown off when a subject blows air while puckering the lips 720.

In this case, the trigger motion of the subject incurring a reaction may be recognized based on the pre-stored motion characteristics.

For example, it is possible to insert a moving effect into a sticker design element by pre-storing trigger motions of several subjects and presetting reaction motions corresponding to each stored trigger motions.

Alternatively, a user may directly input the motions of the subject (air-blowing motion in this embodiment) causing the reaction through the user terminal, and may set reaction motions (the subject disappears out of the screen while being moved by wind in this embodiment) with respect to the motion of the subject to give a moving effect to the sticker design element 710.

For example, a user may select a menu for inputting the motion of the subject causing the reaction in the sticker creation tool of the photographing application, and may input a trigger action of the subject causing the reaction to the sticker design element based on the displayed motion of the subject being currently photographed.

In this case, the same motion may be repeated a plurality of times such that the correct motion is stored, and when the same motion is repeated within an error range to such an extent that the terminal can memorize the corresponding motion, an “OK” sign may be issued.

Then, by setting the reaction motion of the sticker design element with respect thereto, the motion of the sticker design element responding to the inputted trigger motion of the subject may be freely set.

When the sticker created including the motion elements is shared with other terminals, if the shared sticker is applied to another subject displayed on another terminal, it is possible to reproduce the moving effect that the sticker design element is blown off by the wind and disappears out of the screen on the corresponding terminal by sensing the motion in which the applied subject puckers the lips and blows air.

In this case, when storing the user-created sticker, it is preferable that the terminal stores information on the motion causing reaction and motion effect information of the sticker design element responding to the motion together.

Thus, it is possible to give a moving effect to the sticker design element, thereby enhancing the freedom degree of motion and shape of the sticker desired by a user.

Combination of First Mode and Second Mode

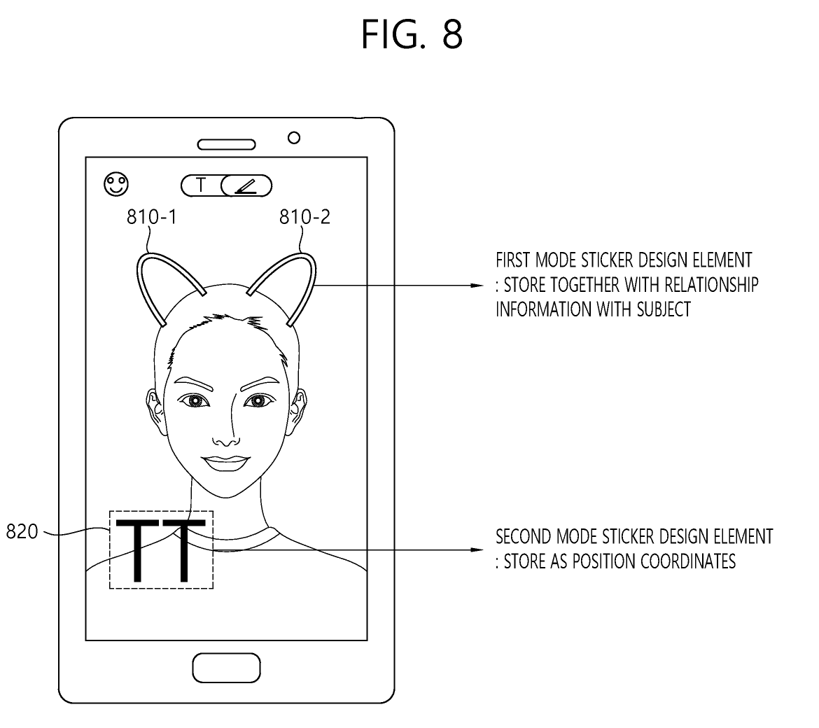

FIG. 8 is a view illustrating a screen displaying a user-created sticker designed by combining a first mode and a second mode of a method of generating a user-created sticker according to an embodiment of the present invention.

Referring to FIG. 8, one user-created sticker may include a sticker design element of the first mode and a sticker design element of the second mode together.

Sticker design elements 810-1 and 810-2 are sticker design elements created through the first mode that is a mode of recognizing a subject, and are stored together with synchronization points with a face contour.

Accordingly, the sticker design elements 810-1 and 810-2 may be together moved and resized based on the synchronization points according to the movement of the face.

On the other hand, since the sticker design element 820 of the second mode which is displayed while being still in the screen does not consider the association with the subject, only the pixel position coordinates of the sticker design element may be simply considered.

As shown in FIG. 8, when the user-created sticker in which the first mode and the second mode are combined is stored, overall information of the sticker including the number of the sticker design elements constituting the whole sticker and information on each sticker design element may be stored.

Here, the information on each sticker design element may include first flag information (whether the mode is the first mode or the second mode) indicating the mode of each sticker design element, second flag information (whether the type is text or drawing) indicating the type of the sticker design element, information on the coordinates of the sticker design element, and information (e.g., information on the color, size or thickness, and tilt of the line or text forming the sticker design element, motion-to-motion effect, etc.) about the sticker design element itself. In the case of the sticker design element of the first mode, contour information of the associated subject and synchronization point information may be together stored.

According to another embodiment of the present invention, a text design element among a plurality of design elements created by a user may be set to have the features of the second mode, and a drawing design element may be set to have the features of the first mode.

According to another embodiment of the present invention, a sticker manually created by a user as described above and a sticker basically provided by an application may be used in combination with each other.

That is, in a single photographing screen including a first subject and a second subject, the basically provided sticker may be applied to the first subject, and the user-created sticker may be applied to the second subject.

Alternatively, after the pre-stored sticker is recalled, a user-created sticker may be created in a form of decorating in addition to the corresponding sticker.

User-Created Sticker Creating Apparatus

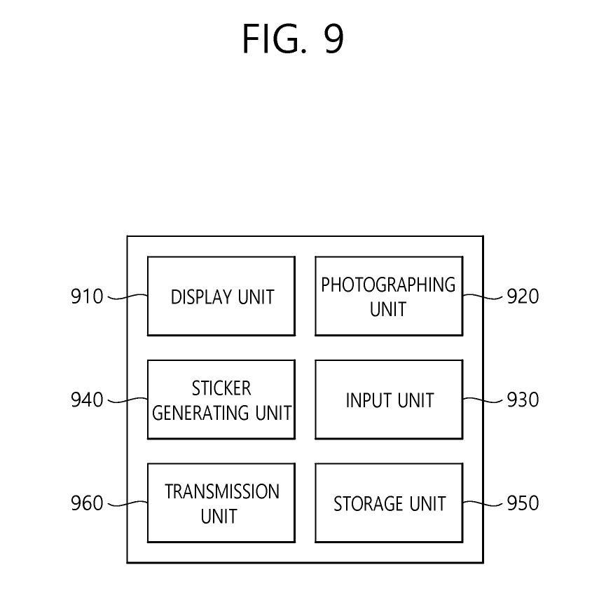

FIG. 9 is a view illustrating an apparatus for generating a user-created sticker according to an embodiment of the present invention.

As shown in FIG. 9, a user-created sticker generating apparatus 900 may include a display unit 910, a photographing unit 920, an input unit 930, a sticker generating unit 940, a storage unit 950, and a transmission unit 960.

Referring to FIG. 9, the display unit 910 displays all data related to the present invention such as a subject photographed by a camera of the apparatus, a captured image captured by the camera, a moving image generated through a sticker using the captured image, and a video generated through a GIF photographing mode, and related effects.

The display unit 910, which is a unit for displaying data, may be a touch screen provided in a smart phone.

The photographing unit 920, which is an image photographing unit such as a camera, photographs a subject through any one of a normal photographing mode and a GIF (moving picture) photographing mode, and outputs the photographed result through the display unit 910.

The input unit 930 is a component that receives input related to a specific command from a user.

The input unit 930 may be referred to as a user interface, and all commands of a user are inputted through the input unit 930.

For example, the input unit 930 may include input devices such as a keyboard and a mouse.

In an embodiment of the present invention, the input unit 930 may be implemented as a touch screen.

That is, the input unit 930 and the display unit 910 may be integrated into one component by a touch screen.

The sticker generating unit 940 generates a sticker according to a user input using photographed subjects, photographed pictures, and/or moving pictures.

The sticker generating unit 940 may identify the coordinates of each of the sticker design elements generated according to the user input, and may generate a user-created sticker based on relationship information associating the sticker design element and the subject or the display screen in accordance with the corresponding coordinates.

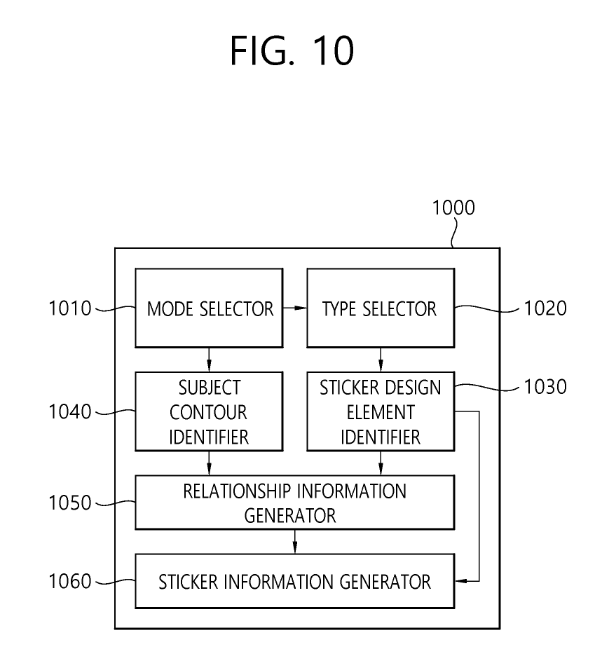

A more specific configuration of the sticker generating unit 940 will be described in detail with reference to FIG. 10.

The storage unit 950 stores all data for carrying out the present invention, for example, edge templates, algorithms, applications, data related to pre-stored stickers, information related to a user-created sticker newly created through the sticker generating unit 940, captured images, moving pictures, videos, and the like.

In this case, when a user-created sticker is created and the storage button of the sticker is selected by a user in the displayed state, the storage unit 950 may store the user-created sticker based on the information related to the corresponding sticker.

The transmission unit 960 transmits information related to the user-created sticker stored in the storage unit 950 to a server or other devices.

FIG. 10 is a detailed view illustrating a sticker generating unit of a user-created sticker generating apparatus according to an embodiment of the present invention.

As shown in FIG. 10, a sticker generating unit 1000 according to an embodiment of the present invention may include a mode selector 1010, a type selector 1020, a sticker design element identifier 1030, a subject contour identifier 1040, a relationship information generator 1050, and a sticker information generator 1060.

Referring to FIG. 10, the mode selector 1010 selects a mode for creating a sticker by a control signal generated through a user input in which a user clicks on an icon at the top of a screen while a subject photographed by a camera is being displayed by the execution of a sticker creation tool.

The selectable modes may include a first mode for recognizing a subject and creating a sticker design element in association with the subject, and a second mode for generating a sticker design element regardless of the subject.

The type selector 1020 is a component for selecting whether to express the user input for creating a sticker design element as a text or a drawing.

This may also be selected through a user input.

The sticker design element identifier 1030 identifies the sticker design element generated according to the type selected by the type selector 1020.

In this case, the coordinates, thickness, shape, size, etc. of the sticker design element may be identified.

The coordinates means the coordinates of the pixel representing the sticker design element.

Also, the sticker design element identifier 1030 identifies the mode and type-related information of the sticker design element.

The information identified by the sticker design element identifier 1030 is provided to the sticker information generator 1060 so as to be used when the sticker is stored.

The subject contour identifier 1040 and the relationship information generator 1050 are components that operate when the mode selector 1010 selects the first mode.

Accordingly, in the case of sticker design element for which the second mode is selected, the operations of the subject contour identifier 1040 and the relationship information generator 1050 are skipped, and information on the coordinates, thickness, shape, size, etc. of the sticker design element identified by the sticker design element identifier 1030 is generated as storable sticker information.

That is, the coordinates of the sticker design element are utilized as the relationship information indicating the association with the display screen, and other information such as the thickness, shape, size, etc. are generated into storable information of the user-created sticker as information of the sticker design element itself.

The subject contour identifier 1040 that operates when the first mode is selected stores a figure including all of the sticker design elements as an image, and identifies a subject in the stored image to identify the contour of the identified subject.

The relationship information generator 1050 generates relationship information associating the identified subject with the sticker design element.

The relationship information generator 1050 identifies the center point of the subject based on the contour of the subject, and generates relationship information indicating the relationship between the center point and the contour of the subject and the relationship between the center point or the contour of the subject and the sticker design element.

According to another embodiment of the present invention, the relationship information generator 1050 detects a synchronization point which is a specific point for associating the edge template related to the subject with the sticker design element, and utilizes the synchronization point as the relation information.

As described above, the synchronization point may be detected as a point having a specific relationship with a start point and an end point of the sticker design element among the points on the contour of the subject.

The relationship information generator 1050 may detect a point on the edge template corresponding to the synchronization point, and store the detected point as synchronization point information.

Then, the subject, contour information, and relationship information (which may include the synchronization point information) identified by the subject contour identifier 1040 and the relationship information generator 1050 are provided to the sticker information generator 1060.

The sticker information generator 1060 is a component that generates various kinds of information stored in association with a sticker when a user selects a storage icon to store a sticker created by a user.

In the case of the first mode, the sticker information generator 1060 may generate user-created sticker information using the subject contour information, the center point information, the synchronization point information, the relationship information (e.g., information on distances between each synchronization point and the start point or end point) between the synchronization point and the sticker design element, and information on the coordinates of the sticker design element.

The generated information is stored in the storage unit when a user selects the storage icon.

User-Created Sticker Sharing System

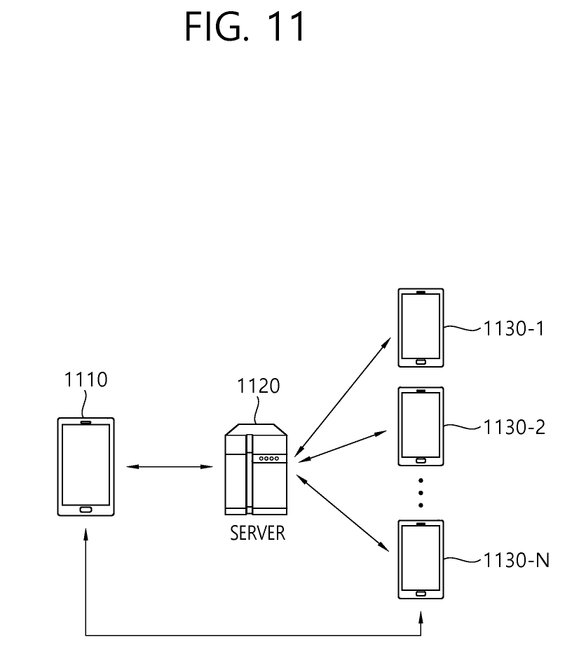

FIG. 11 is a conceptual view illustrating a system for sharing a user-created sticker according to an embodiment of the present invention.

As shown in FIG. 11, a system according to an embodiment of the present invention may include a user-created sticker generating apparatus 1110, a server 1120, and user-created sticker receiving apparatuses 1130-1 to 1130-N.

Referring to FIG. 11, the user-created sticker generating apparatus 1110 generates and stores a sticker that is created in accordance with the user's preference.

The stored stickers may be transmitted to the server 1120 or the user-created sticker receiving apparatuses 1130-1 to 1130-N via a wired or wireless network.

The server 1120 is a server for managing a photographing application, and takes charge of receiving and distributing stickers created by the user-created sticker generating apparatus 1110.

The server 1120 basically distributes applications, and manages users who use the applications.

The management of users is performed based on a login process through the account and password.

That is, a user logged-in through the account and password may upload a sticker created by him/her to a public sticker page managed by the server 1120 using the user-created sticker generating apparatus 1110.

A user of the user-created sticker generating apparatus 1110 may send a sticker created by him/her to another user's apparatus (in this embodiment, the user-created sticker receiving apparatuses 1130-1 to 1130-N) managed by the server 1120 through the server 1120 or directly.

The user-created sticker receiving apparatuses 1130-1 to 1130-N may receive the created stickers through the server 1120 or directly from the user-created sticker generating apparatus 1110, and may download the received sticker according to a user's preference.

When the downloading is completed, a user of the user-created sticker receiving apparatuses 1130-1 to 1130-N may apply the sticker design elements of the downloaded user-created sticker to a pre-stored photograph and video or a subject that is currently being photographed based on the relationship information.

According to another embodiment of the present invention, the user-created sticker may be traded for a fee via the server 1120.

That is, the server 1120 may manage the cash used in an application, and when the user-created sticker receiving apparatuses 1130-1 to 1130-N download stickers created by a specific user via the server 1120, a fee may be charged.

In this case, a user who created the charged sticker may receive the charged money or the fee of a certain rate through his/her bank account associated with the corresponding account.

The system or apparatus described above may be implemented as a hardware component, a software component, and/or a combination of hardware components and software components.

For example, the systems, apparatuses, and components described in the embodiments may be implemented using at least one general-purpose computer or special-purpose computer such as a processor, a controller, an Arithmetic Logic Unit (ALU), a digital signal processor, a microcomputer, a Field Programmable Array (FPA), a Programmable Logic Unit (PLU), a microprocessor, or any other device capable of executing and responding to instructions.

The processing device may execute an Operating System (OS) and one or more software applications running on the operating system.

In addition, the processing device may access, store, manipulate, process, and create data in response to execution of software.

For convenience of understanding, the processing device may be described as being used singly, but those skilled in the art can see that the processing device can include a plurality of processing elements and/or various types of processing elements.

For example, the processing device may include a plurality of processors or one processor and one controller.

Also, other processing configurations such as a parallel processor may be implemented.

Software may include computer programs, codes, instructions, or a combination thereof, and may configure the processing device to operate as desired or instruct the processing device independently or collectively.

In order to be interpreted by the processing device or provide instructions or data to the processing device, software and/or data may be permanently or temporarily embodied in any type of machine, components, physical devices, virtual equipment, computer storage media or devices, or transmitted signal waves.

Software may be distributed over computer systems connected via a network, and may be stored or executed in a distributed manner.

Software and data may be stored in one or more computer readable recording media.

The methods according to the embodiments may also be embodied into a form of program instruction executable through various computer systems, and may be recorded in computer readable media.

The computer readable media may include program instructions, data files, data structures, or combinations thereof.

The program instructions recorded in the media may be what is specially designed and configured for the embodiments, or may be what is well-known to computer software engineers skilled in the art.

Examples of computer readable recording media include hard disk, magnetic media such as floppy disks and magnetic tapes, optical media such as CD-ROM and DVD, magneto-optical media such as floptical disks, and hardware devices such as ROM, RAM, and flash memories, which are specially configured so as to store and perform program instructions.

Examples of program instructions include high-level language codes which can be executed by computers using an interpreter and the like, as well as machine language codes which are made by a compiler.

The hardware devices described above may be configured to operate as one or more software modules in order to perform the operations of the embodiments, and vice versa.

Although the embodiments have been described by limited implementations and drawings, it will be apparent to those skilled in the art that various modifications and equivalents can derive from the above descriptions.

For example, it is possible to achieve an appropriate result even though the described techniques are performed in a different order from the described methods, and/or components of the described systems, structures, devices, circuits, etc. are coupled or combined in a different form the described methods or replaced or substituted by other components or equivalents.

According to a method and an apparatus for creating a user-created sticker according to an embodiment of the present invention, a user may directly create a sticker and share the created sticker, thereby enhancing the fun factor of photograph and video and improving the photographing satisfaction of a user.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for creating a user-created sticker, the method comprising:
displaying a subject;
executing a tool for designing a sticker for decorating the displayed subject;
receiving a user input for sticker design;
identifying coordinates of a sticker design element generated according to the user input;
generating relationship information associating the sticker design element with at least one of the subject and a display screen based on information on the identified coordinates of the sticker design element; and
storing the user-created sticker based on the generated relationship information and the sticker design element.

2. The method of claim 1, further comprising:
identifying a contour of the subject;
identifying a center point of the subject based on the identified contour of the subject; and
generating relationship information by considering the center point of the subject, the contour of the subject, and the coordinates of each sticker design element.

3. The method of claim 1, further comprising:
identifying a contour of the subject; and
generating a synchronization point that associates the sticker design element with the identified contour of the subject based on the coordinates of the sticker design element,
wherein the user-created sticker is stored based on the synchronization point and the sticker design element.

4. The method of claim 3, wherein the synchronization point comprises a specific point on the contour of the subject having an association with an end of the sticker design element.

5. The method of claim 1, wherein information stored when the user-created sticker is stored comprises information related to a synchronization point that is a specific point indicating an association between the sticker design element and the subject, and information on the sticker design element itself.

6. The method of claim 1, wherein the sticker design elements move together with the subject based on the relationship information when the subject moves.

7. The method of claim 1, wherein the sticker design element varies so as to have a size proportional to the size of the subject in response to a change in size of the subject.

8. The method of claim 1, wherein the sticker design element is created in plurality, and
wherein the plurality of sticker design elements have relationship information with at least one subject.

9. The method of claim 1, further comprising recognizing a specific motion of the subject and giving a moving effect to the user-created sticker in response to the recognized motion.

10. The method of claim 1, wherein the sticker design element comprises at least one of a text, a drawing, a figure, an image, and a functional figure that calls a sound and an animation.

11. The method of claim 10, wherein when a drawing input is selected, a menu for selecting at least one of a thickness, a shape, and a color of a line for drawing is provided.

12. The method of claim 10, wherein when a text input is selected, a sticker generating apparatus calls a keyboard that is basically provided and allows a user to enter a text using the keyboard.

13. The method of claim 10, wherein after a text is inputted, at least one of a size, a position, and a tilt of the inputted text is changeable.

14. The method of claim 10, wherein the figure and the image are called from a camera or an album to be used.

15. The method of claim 10, wherein the figure comprises a still figure, an animation figure, or a 3D object.

16. The method of claim 1, wherein the user-created sticker is created in a state of being photographed by a camera or is created using a pre-stored photograph.

17. The method of claim 1, wherein the user-created sticker is created in addition to a pre-stored sticker.

18. An apparatus for creating a user-created sticker, the apparatus comprising:
a display unit for displaying a subject;
an input unit receiving a user input;
a sticker generating unit executing a tool for designing a sticker for decorating the displayed subject through a control signal inputted through the input unit, generating a sticker design element according to a user input for designing a sticker, identifying coordinates of the generated sticker design element, and generating relationship information associating the sticker design element with at least one of the subject and a display screen based on information on the coordinates of the identified sticker design element; and
a storage unit for storing a user-created sticker based on the generated relationship information and the sticker design element.

19. A system for sharing a user-created sticker, the system comprising:
a user-created sticker generating apparatus executing a tool for designing a sticker for decorating a displayed subject through an input unit, generating a sticker design element according to a user input for designing a sticker, identifying coordinates of the generated sticker design element, generating relationship information associating the sticker design element with at least one of the subject and a display screen based on information on the coordinates of the identified sticker design element, storing a user-created sticker based on the generated relationship information and the sticker design element, and transmitting the stored user-created sticker to a server; and
a server for receiving the user-created sticker and distributing the user-created sticker to other apparatuses.

20. The system of claim 19, further comprising a user-created sticker receiving apparatus downloading and using the user-created sticker through the server or directly from the user-created sticker generating apparatus.
